(19) United States
(12) Patent Application Publication
(10) Pub. No.: US 2005/0027403 A1
(43) Pub. Date: Feb. 3, 2005

(54) Parameter identification-based filtering

(76) Inventor: Ikuya Nagai, San Jose, CA (US)

Correspondence Address: MCDERMOTT, WILL & EMERY, 600 13th Street, N.W., Washington, DC, 20005-3096, US

(21) Appl. No.: 10/839,722

(22) Filed: May 6, 2004

Related U.S. Application Data
(60) Provisional application No. 60/468,058, filed on May 6, 2003.

(51) Int. Cl. G06F 17/00

(52) U.S. Cl. 701/1; 701/29

(57) ABSTRACT

Methods and devices for collecting and filtering vehicle parameter identification data. Filtering based on the parameter identification data is established during data collection and concurrently applied to the collected data stream. Various filtering modes can be used to present and analyze the collected data. Also disclosed are devices for analyzing parameter identification data and calculating diagnoses based on them.

### RELATED APPLICATION

This application claims the benefit under 35 U.S.C. § 119(e) of U.S. Provisional Patent Application No. 60/468,058 filed on May 6, 2003, entitled “PID Value Based Filtering Method,” which is incorporated by reference herein in its entirety.

### TECHNICAL FIELD

The present disclosure relates generally to vehicle diagnostics, and more particularly, to methods and devices for measuring various parameter identifications (PIDs) of a vehicle and applying filters to the measured PIDs as these values are captured for real time diagnosis of the vehicle's condition.

### BACKGROUND

Vehicle diagnostics often involve scanning tools that connect to a vehicle and communicate with an on-board computer. The scanning tools assist vehicle technicians in diagnosing potential problems with a vehicle by measuring a variety of PIDs, including voltage, engine speed, temperature, air pressure, emission, and the like. The scanning tool communicates with a vehicle's on-board computer using that computer's communication protocol such as, for example, On Board Diagnostics (OBD) versions 1 and 2. During communication, a scanning tool typically captures current PID conditions from the vehicle and stores them in local memory for analysis.

Unfortunately, the variety of data captured by scanning tools can be difficult for a technician to sort through and analyze. Some scanning tools can display PID values as graphs, which can be difficult to read in some cases. For example, such graphs present raw PID data streams that often contain glitches (invalid data created by various electrical noises in the vehicle). The glitches often have uncharacteristically high or low values that can distort the graphs as they re-adjust graphical scales to fit the glitches. The resultant re-adjusted graphs containing glitch data often present relevant data in a minimized display area, such that the relevant data have lost resolution leading to difficulties in data analysis.

Also, the vehicle data analysis often focuses on certain aspects of the PID data such that the relevant data can reside within a narrow range of values. In such cases, the graphical representation for all of the data may minimize the relevant data, causing it to have decreased resolution and resultant difficulties in data analysis.

What is needed is a vehicle diagnostic method and system that filter PID data to selectively present relevant PID data in a more easily visible format as the vehicle PID data are captured.

### SUMMARY

The methods and devices disclosed herein help solve these and other problems by applying selective automotive data filters to real time automotive data. The automotive data may include, for example, PID data. Glitches and other unwanted data are filtered out such that only valid data are displayed, thereby facilitating analysis of the data and reducing false diagnoses based on invalid data.

In one aspect, a method for processing parameter identification data received from a vehicle includes calculating a filter parameter from at least one data value received from the vehicle. The data stream is then filtered by the calculated filter parameter to produce filtered data. The filtered data can be concurrently presented on a display screen or stored for later analysis.

The PID data may be filtered in a variety of ways. For example, a PID data filter value may be selected according to a scalar number, a derivative value, an integral value, or another value based on a predefined set of mathematical equations. In addition, a PID data filter may use a range of values, such that PID data of a certain value may be filtered out within a finite range of values or, alternatively, outside threshold values defining the finite range of values.

In another aspect, a PID filter duration threshold value may be set to filter out a particular type of PID data within the duration threshold values or, alternatively, outside of the duration threshold values.

In yet another aspect, multiple PID filters may be combined to filter PID data based on a plurality of conditions set in each of the multiple PID filters. A combination of PID filters may be defined with Boolean operators such as “or,” “and,” or “not,” for example. Alternatively, PID filter combinations may be defined by conditional constraints or sequential event constraints, in which conditions or sequences detected in real time PID data by a first PID filter may invoke the application of a second PID filter to the real time PID data.

Additional aspects and advantages of the present disclosure will become readily apparent to those skilled in this art from the following detailed description, wherein only exemplary embodiments are shown and described, simply by way of illustration of the best mode contemplated for carrying out the present disclosure. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### BRIEF DESCRIPTION OF THE DRAWINGS

The accompanying drawings illustrate several embodiments and, together with the description, serve to explain the principles of the present disclosure.

FIG. 1 illustrates an exemplary advanced graphing scanner for collecting and filtering real time PID data.

FIGS. 2A and 2B illustrate an effect of an exemplary first filter embodiment on vehicle PID data.

FIGS. 3A and 3B illustrate an effect of an exemplary second filter embodiment on vehicle PID data.

FIG. 4 illustrates a method for processing parameter identification data received from a vehicle according to an embodiment of the present disclosure.

### DETAILED DESCRIPTION OF THE EMBODIMENTS

The present disclosure is now described more fully with reference to the accompanying figures, in which several embodiments are shown. The embodiments described herein may include or be utilized with any appropriate engine having an appropriate voltage source, such as a battery, an alternator and the like, providing any appropriate voltage, such as about 12 Volts, about 42 Volts and the like. The embodiments described herein may be used with any desired system or engine. Those systems or engines may comprise items utilizing fossil fuels, such as gasoline, natural gas, propane and the like, electricity, such as that generated by battery, magneto, solar cell and the like, wind and hybrids or combinations thereof. Those systems or engines may be incorporated into other systems, such as an automobile, a truck, a boat or ship, a motorcycle, a generator, an airplane and the like.

One skilled in the art will recognize that methods, apparatus, systems, data structures, and computer readable media implement the features, functionalities, or modes of usage described herein. For instance, an apparatus embodiment can perform the corresponding steps or acts of a method embodiment.

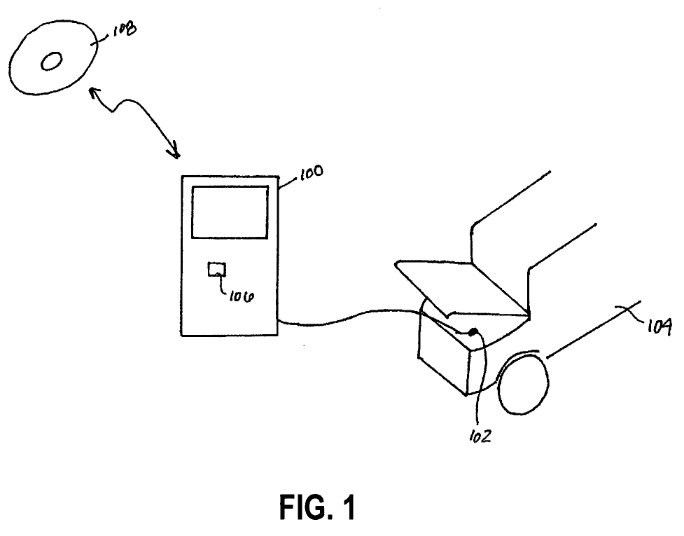

FIG. 1 illustrates an exemplary advanced graphing scanner for collecting and filtering real time automotive data from a vehicle. The exemplary embodiments disclosed herein are applicable to PID data streams, however the inventions are equally applicable to other types of automotive data, and are not to be considered limited to PID or any other specific type of automotive data.

An exemplary advanced graphing scanner 100 comprises a processor that may be operatively connected to the on-board computer 102 of a vehicle 104. Advanced graphing scanner 100 communicates with on-board computer 102 using on-board computer's 102 communication protocol. Common protocols may include ON-BOARD DIAGNOSTICS (OBD) versions 1 or 2, or other manufacturer-developed protocols. In operation advanced graphing scanner 100 receives PID data from the vehicle through the on-board computer 102, applies one or more filter algorithms to the data stream with the processor, and presents the filtered real time PID data to a user such as on a display screen of advanced graphing scanner 100. The user may then view the filtered, real time PID data to evaluate the data and to make diagnoses regarding the condition of the vehicle.

In an exemplary embodiment, the filters employed by the processor of advanced graphing scanner 100 filters glitches or other unwanted PID data according to a user's specified filter conditions. The filter conditions may be specified by the user using feature selection tools included in advanced graphing scanner 100, which may be accessed, for example, by keypad 106 or other user input device.

Various embodiments of exemplary PID-based filter logic may be embodied as a computer-readable medium 108 containing software that is implemented into an existing PID collection and analysis system platform or diagnostic system (such as the Modular Diagnostic Information System (MODIS), which is commercially available from Snap-on Diagnostics, Inc. of San Jose, Calif.). Computer-readable medium 108 may include magnetic storage media, compact disc, computer memory, or other form of computer-readable data storage media. Computer readable medium may also comprise local data storage contained within advanced graphing scanner 100. And, software or algorithms stored on computer readable medium 108 may be transferred to advanced graphing scanner 100 by direct input means such as a flash memory slot or other data input, or by other communication means including wireline or wireless transmission. Of course, it is understood that other diagnostic platforms may be utilized in accordance with the disclosure herein. Further, a filter-enabled PID collection and analysis system according to the present disclosures may include additional features including, but not limited to, various scopes, multimeters, and direct ports for specific engine components. An exemplary filter-enabled PID collection and analysis system may comprise various separate components in a laboratory setup, or may comprise collectively contained components in a compact handheld device.

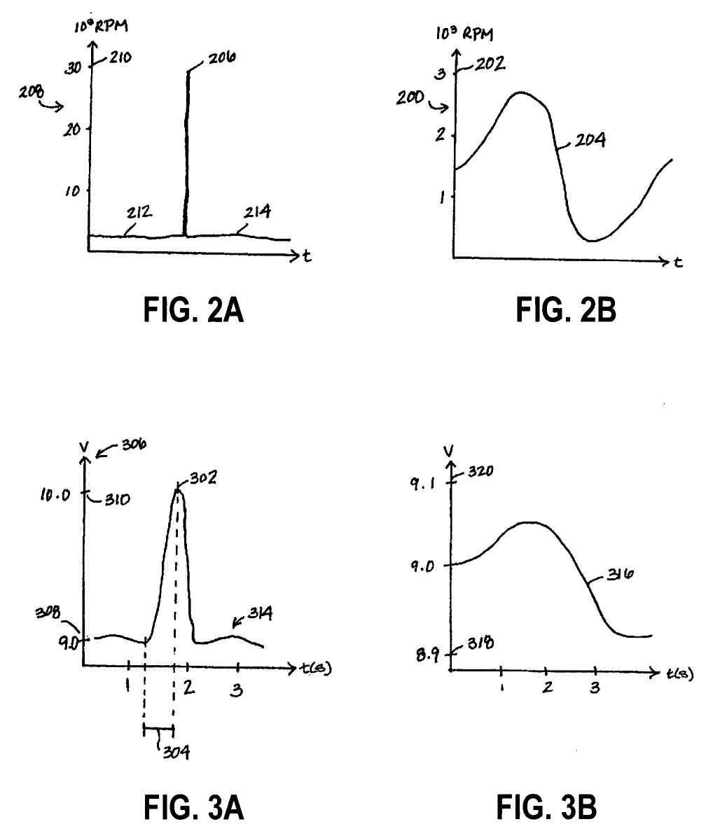

FIG. 2A illustrates exemplary unfiltered PID data and FIG. 2B illustrates an effect of an exemplary level filtering embodiment on the vehicle PID data. In an exemplary embodiment, level filtering may employ a minimum threshold value, a maximum threshold value, or both, as a filtering condition, and filter all PID data below or above that threshold value. For example, in the case that an engine's RPM should not exceed 3000, it may be assumed that PID data reflecting an engine RPM of 3000 or higher are not valid data. Therefore, the scale of an RPM axis 200 would have its greatest value at approximately 3000 RPM as indicated at point 202. Data 204, below 3000 RPM, may then be displayed in a form that is visible to a user viewing the graph. Collection of invalid data contained in a greater-than-3000 RPM glitch 206, would alter the scale for display of other valid data, by adjusting the scale of RPM axis 208 to accommodate the data glitch that is above 3000 RPM. For example, if RPM glitch 206 is approximately 30000 RPM, RPM axis 208 will likewise have its greatest value at approximately 30000 RPM as indicated at point 210. The result would be that the scale of the valid data that is below 3000 RPM is significantly reduced, making these valid data 212, 214 more difficult to analyze. Therefore, a level filter may be set to have a maximum threshold value of 3000, in which case all PID data may be filtered out when the engine speed exceeds 3000 RPM. The level filter thus preserves the appropriate scale of RPM axis 200 for display of valid data that are in the normal range below 3000 RPM, facilitating their display and analysis. It is to be understood that the level filter embodiment is not limited to a threshold value of 300 or to the PID for engine speed. Rather, the level filter embodiment may be employed with any threshold value, and may be applied to any PID data type.

FIG. 3A illustrates exemplary unfiltered PID data and FIG. 3B illustrates an effect of an exemplary transition filtering embodiment on vehicle PID data. In an exemplary embodiment, transition filtering excludes data from the PID data set when a specific change in PID data is detected. For example, in the case that the voltage should not jump from 9 volts to 10 volts within a one second interval, data indicating such a transition may be assumed to be invalid. This is illustrated in the data of FIG. 3A, where the data jumps from approximately 9 volts at point 300 to approximately 10 volts at point 302, within a time period 304 less than one second. Collection of the invalid data point 302 would alter the scale of voltage axis 306 to span the range from 9 volts 308 to 10 volts 310, forcing the valid data indicated generally at 312 and 314 into a compacted region of the graphical display, causing analysis of the valid data 312, 314 to be more difficult. Thus, a transition filter may be set with a threshold slope value that describes a 9 volt to 10 volt change within one second or less. Upon detection of this threshold slope value in the collected PID data, these data reflecting the slope may be filtered out. The result is that the valid data shown generally at 306 and 308 are represented in a full scale depiction, as shown at 316. Because the voltage scale retains a smaller range, such as a span from 8.9 volts 318 to 9.1 volts 320, valid data 316 is plotted on a more visible scale. It is to be understood that any threshold slope value may be utilized in the transition filtering embodiment, and that such threshold slope value may be derived from any maximum or minimum value. Further, filtering of data along a threshold slope condition is not limited to a slope of any particular direction. Rather, a transition filter may be utilized to filter data reflecting a positive transition value as well as data reflecting a negative transition value. Moreover, application of the transition filter embodiment is not limited to voltage data. Rather, the transition filter embodiment may be applied to any PID data type.

In another exemplary embodiment, concurrent filtering excludes data from the PID data set when any one of a plurality of PID data types selected as the basis for a specified filter condition displays the specified condition. For example, either an engine speed above 3000 RPM or a sudden voltage increase from 9 volts to 10 volts might indicate invalid PID data, as described above. The invalid data may not be limited to data of the type in which the glitch appears. Rather, a glitch in one type of PID data may indicate invalidity of all PID data at that moment in time. Therefore, a concurrent filter may be set with multiple threshold values to detect various types glitches that would indicate invalid data, and filter multiple types of PID data in response to a glitch in only one type of PID data. For example, a concurrent filter based on the level filter and transition filter described above may employ two separate threshold values, representing the engine speed threshold value of 300 RPM and the voltage transition threshold value of a 1 volt increase between 9 volts and 10 volts. The concurrent filter would then remove PID data from the data set whenever either of those threshold conditions were met. A concurrent filter may be configured to utilize threshold values and threshold conditions for any of the PID data types, and is not limited to application on voltage or engine speed data, or the combination of these.

Another exemplary embodiment comprises consecutive condition filtering embodiment on vehicle PID data. Consecutive filtering excludes data from the PID data set when a specific sequence of data conditions is met. For example, a voltage jump from 9 volts to 10 volts followed by an engine speed exceeding 3000 RPM might indicate invalid data, even though either one of these two conditions on their own, or in the reverse sequence, would not indicate invalid data. In that case, the consecutive filter is set to have a consecutive sequence threshold condition that includes 1) the 9 volt to 10 volt voltage increase, 2) the 3000 RPM engine speed, and 3) the order of occurrence of these two conditions. The consecutive filter would then remove PID data from the data set whenever these two threshold conditions are met and encountered in the specified order. A consecutive condition filter may be configured to utilize threshold values and threshold conditions for any of the PID data types, and is not limited to application on voltage or engine speed data, or to the specific combination of these. Moreover, a consecutive condition filter is not limited to recognizing a voltage increase followed by an engine speed increase. Rather, a consecutive condition filter may be set to remove data based on conditions in any PID data type that occur in any order.

In another embodiment, timed condition filtering may be applied to vehicle PID data. Timed condition filtering excludes data from the PID data set when a certain data condition not only occurs, but also persists for a specified amount of time. For example, a brief increase of engine speed above 3000 RPM may not indicate invalid PID data. However, an increase of engine speed above 3000 RPM for more than 5 seconds may indicate invalid PID data. Therefore, a timed condition filter may employ a threshold condition having both PID value and time duration components. For example, a timed condition filter based on the above example may be set to have a threshold condition of 3000 RPM engine speed and 5 second time duration. In that case, the consecutive filter would remove PID data from the data set whenever the engine speed exceeds 3000 RPM for longer than 5 seconds. In an alternative mode, the consecutive filter may be coupled with a level filter applied to the engine speed data only, to remove the engine speed data that are above 3000 while continuing to collect other PID data during the same time period that the engine speed data are being filtered out. It is to be understood that a timed condition filter may be configured to filter based on any type of PID data, at any threshold value or condition, and may apply any length of time as its time duration component.

In yet another embodiment, derivative filtering may be applied to vehicle PID data. In an exemplary embodiment, derivative filtering excludes data from the PID data set when a specific condition derived from the PID data is encountered. For example, a 1 volt change in PID voltage data may indicate invalid PID data. Unlike other exemplary embodiment previously discussed, the invalid data may be indicated by any 1 volt change, regardless of the starting or ending voltage, and regardless of the direction of the change. Thus, a derivative filter may be set with a threshold voltage difference condition of 1 volt. In that case, the derivative filter would exclude PID data when the voltage PID data experiences a 1 volt change. A derivative filter may be applied to any type of PID data, at any derivative value and in either a positive or negative direction.

In another embodiment, integral value based filtering may be applied to vehicle PID data. In an exemplary embodiment, integral filtering excludes data from the PID data set when the cumulative value (integral) of the captured data meets a user-specified filter condition. For example, the cumulative value of an abnormally high temperature reading may indicate an impossible condition such as, for example, heat energy that would disintegrate the engine. Such a condition may be detected in the PID data of a normal vehicle if, for example, the temperature sensor were unreliable. This may be the case even if the PID data otherwise seem normal. An integral filter would detect such conditions and effectively filter out the invalid temperature PID data, preserving other, valid PID data. Of course, it is to be understood that an integral filter may be applied to any type of PID data, at any integral value and in either a positive or negative direction.

Of course it is to be understood that many other filters or combinations of the filters described above may be constructed in accordance with the disclosures herein. The specification is intended to relate generally to application of PID data filters to PID data collection wherein the filters are based upon derivative information from the PID data itself. Many such derivations of PID data are possible, each of which may be employed in a filter to be applied to the PID data during further PID data collection. The above examples are not to be read in a limiting sense, but as illustrative with respect to several exemplary embodiments that are within the scope of the present disclosures.

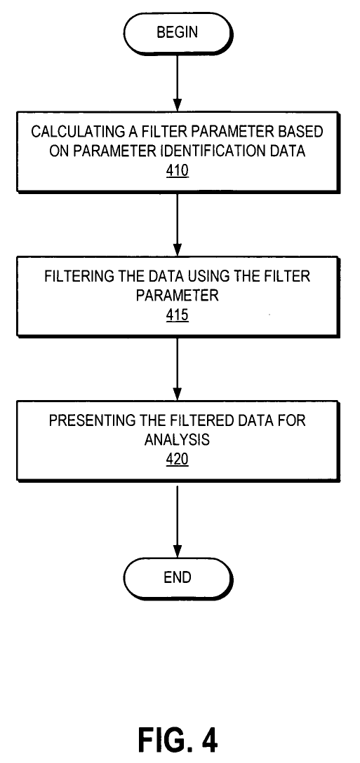

FIG. 4 illustrates a method for processing parameter identification data received from a vehicle according to an embodiment of the present disclosure. In the illustrated embodiment, the process begins with calculating 410 a filter parameter based on the PID data. As described above, the filter parameter represents one or more triggers, conditions, or thresholds by which wanted or unwanted data can be identified and/or removed from the PID data stream.

The PID data received from the vehicle is filtered 415 using the filter parameter. In an embodiment, the unwanted data is identified as the data stream is being received from the vehicle's on-board diagnostics. The filtered data is presented 420 on the display screen of the advanced graphing scanner 100. As one skilled in the art will appreciate, the filtered data may include unwanted data that is flagged as such for display purposes. That is, the filtered data may or may not include that unwanted data values or samples.

Having described embodiments of parameter identification-based filtering (which are intended to be illustrative and not limiting), it is noted that modifications and variations can be made by persons skilled in the art in light of the above teachings. For example, the embodiments described herein may include or be utilized with any type of vehicle parameter data streams such as motorcycles, airplanes; utility vehicles and the like, and is not limited to use with automobiles. Moreover, filters may be based on PID derived conditions other than the particular examples disclosed herein, and may be combined in various fashions in constructing PID data filters. It is therefore to be understood that changes may be made in the particular embodiments disclosed that are within the scope and spirit of the invention as defined by the appended claims and equivalents.

1. A method for processing parameter identification data received from a vehicle, the method comprising:
calculating a filter parameter from at least one data value received from the vehicle;
filtering the parameter identification data using the filter parameter to produce filtered data; and
presenting the filtered data for analysis.

2. The method of claim 1, wherein the filter parameter comprises at least one of a level filter, a transition filter, a concurrent filter, a consecutive condition filter, a timed condition filter, a derivative filter, and an integral filter.

3. The method of claim 1, wherein the filter parameter comprises a plurality of conditions.

4. The method of claim 1, wherein the filter parameter includes at least one of a minimum threshold value and a maximum threshold value.

5. The method of claim 1, wherein the filter parameter includes a threshold slope.

6. The method of claim 1, wherein the filter parameter includes a threshold value and a threshold condition.

7. The method of claim 1, wherein the filter parameter includes a threshold condition and a time duration.

8. The method of claim 1, wherein the filter parameter includes a difference condition.

9. The method of claim 1, wherein the filter parameter includes an integral value.

10. The method of claim 1, wherein filtering the parameter identification data further comprises:
capturing a data stream from the vehicle; and
performing a real time filtering of the data stream.

11. The method of claim 1, wherein filtering the parameter identification data further comprises:
identifying unwanted data based on the filter parameter.

12. The method of claim 1, wherein presenting the filtered data further comprises:
determining a display range corresponding to minimum and maximum values of the filtered data; and
displaying, on the display screen, the filtered data within the display range.

13. An apparatus for processing parameter identification data received from a vehicle, the apparatus comprising:
a processor configured to calculate a filter parameter from at least one data value received from the vehicle and to filter the parameter identification data using the filter parameter to produce filtered data; and
a display screen operatively coupled to the processor and configured to present the filtered data for analysis.

14. The apparatus of claim 13, wherein the filter parameter comprises at least one of a level filter, a transition filter, a concurrent filter, a consecutive condition filter, a timed condition filter, a derivative filter, and an integral filter.

15. The apparatus of claim 13, wherein the filter parameter comprises a plurality of conditions.

16. The apparatus of claim 13, wherein the filter parameter includes at least one of a minimum threshold value and a maximum threshold value.

17. The apparatus of claim 13, wherein the filter parameter includes a threshold slope.

18. The apparatus of claim 13, wherein the filter parameter includes a threshold value and a threshold condition.

19. The apparatus of claim 13, wherein the filter parameter includes a threshold condition and a time duration.

20. The apparatus of claim 13, wherein the filter parameter includes a difference condition.

21. The apparatus of claim 13, wherein the filter parameter includes an integral value.

22. The apparatus of claim 13, wherein the processor is further configured to capture a data stream from the vehicle and to perform a real time filtering of the data stream.

23. The apparatus of claim 13, wherein the processor is further configured to identify unwanted data based on the filter parameter.

24. The apparatus of claim 13, wherein the processor is further configured to determine a display range corresponding to minimum and maximum values of the filtered data; and the display screen is further configured to display the filtered data within the display range.

25. An apparatus for processing parameter identification data received from a vehicle, the apparatus comprising:
means for calculating a filter parameter from at least one data value received from the vehicle;
means for filtering the parameter identification data using the filter parameter to produce filtered data; and
means for presenting the filtered data for analysis.
